(19) United States
(12) Patent Application Publication
(10) Pub. No.: US 2025/0045615 A1
(43) Pub. Date: Feb. 6, 2025

(54) SYSTEM AND METHOD FOR QUANTUM MICROGRID STATE ESTIMATION

(71) Applicant: The Research Foundation for The State University of New York, Albany, NY (US)

(72) Inventors: Peng ZHANG, Jericho, NY (US); Fei FENG, Lake Grove, NY (US); Yifan ZHOU, Stony Brook, NY (US); Zefan TANG, Willington, CT (US)

(21) Appl. No.: 18/718,281

(22) PCT Filed: Jan. 5, 2023
(86) PCT No.: PCT/US2023/010183

§ 371 Date: Jun. 10, 2024

Related U.S. Application Data
(60) Provisional application No. 63/296,604, filed on Jan. 5, 2022.

(51) Int. Cl. G06N 10/20; G06N 10/60

(52) U.S. Cl. CPC G06N 10/20; G06N 10/60

(57) ABSTRACT

A method of performing state estimation for a microgrid system includes: obtaining a general quantum state estimation model for swing-bus-contained microgrid systems; establishing a state estimation formulation through quantum language; assigning quantum registers used during a quantum state estimation iteration; generating a quantum-circuit-based state estimation solver for performing quantum phase estimation, controlled rotation, and inverse quantum phase estimation; generating a preconditioned quantum linear solver for an ill-conditioned state estimation iteration; iteratively optimizing voltage and residual vectors while iteratively updating preconditioned errors by the state estimation solver, the optimizing and updating iterations continuing until the linear solver reaches convergence; obtaining a quantum state estimation model for hierarchical-based microgrid systems including droop and/or secondary control modes; establishing an enhanced quantum state estimation framework including the state estimation solver and the linear solver; and generating an enhanced state estimation output for controlling one or more parameters of the microgrid system.

### CROSS-REFERENCE TO RELATED APPLICATIONS

This application is the U.S. National Phase of PCT/US2023/010183, filed on Jan. 5, 2023, and claims the benefit of U.S. Provisional Patent Application No. 63/296,604, filed on Jan. 5, 2022, entitled “System and Method for Quantum Microgrid State Estimation,” the disclosures of which are incorporated by reference herein in their entireties for all purposes.

### STATEMENT OF GOVERNMENT RIGHTS

This invention was made with government support under contract number OIA-2040599 awarded by the National Science Foundation. The government has certain rights in the invention.

### BACKGROUND

The present invention relates generally to the electrical, electronic and computer arts, and, more particularly, to a system and method for microgrid state estimation.

Microgrid is a proven paradigm that can flexibly manage distributed energy resources (DERs) and ensure the electricity resiliency against outages. Among many microgrid functions, state estimation is of fundamental importance, as it provides valuable resources for online monitoring and control of microgrids. Basic requirements for microgrid state estimation primarily include accuracy, efficiency and resiliency against noises (see, e.g., A. Primadianto et al., “A Review on Distribution System State Estimation,” IEEE Trans. on Power Systems, vol. 32, no. 5, pp. 3875-3883, 2017, the disclosure of which is incorporated by reference herein in its entirety).

State estimation is an important element of energy management systems, at least in part because it allows a system operator to control and monitor prescribed parameters of an electric power system. The state of the power system can be estimated based on supervisory control and data acquisition (SCADA) measurements, phasor measurement unit (PMU) measurements, and other measurements known in the art. Some of the most important functions of EMS, such as, but not limited to, contingency analysis, optimal power flow, and security assessment, are based in large part on state estimation.

For modern microgrids, an increasingly urgent and important demand for high-frequency state estimation is caused, at least in part, by community expansion, a high penetration of uncertain renewables, and volatile operational conditions, among other factors. However. the complexities of conventional state estimation methods scale polynomially with the problem size, which makes those methods no longer suitable for a future grid with formidable real-time operation requirements.

Quantum computing provides a promising solution for overcoming the complexity issue. Unlike classical computing. quantum computing requires fewer bits (i.e., qubits) to handle a complicated problem. For microgrid state estimation, one main bottleneck is to establish an efficient solver for a sparse linear system of equations. Currently, there are two main types of quantum linear system algorithms: hybrid quantum/classical algorithms: and quantum-circuit-based algorithms. Hybrid algorithms are developed for the noisy intermediate-scale quantum (NISQ) era. Examples include the Variational Quantum Linear Solver and quantum random walk algorithms. However, the inevitable computation and optimization processes on classical computers have made most hybrid algorithms heuristic. As a consequence, the convergence and efficiency of hybrid algorithms cannot be strictly guaranteed.

In addition to the complexity issue, high-volume state measurement and information exchange also make microgrids vulnerable to exogenous disturbances (see, e.g., S. Bi, et al., “Graphical Methods for Defense Against False-Data Injection Attacks on Power System State Estimation,” IEEE Trans. on Smart Grid, vol. 5, no. 3, pp. 1216-1227, 2014, the disclosure of which is incorporated by reference herein in its entirety). However, conventional microgrid state estimation methods typically follow classical power flow formulations, which have ignored the features of droop-based microgrids where multiple DERs, instead of a swing bus, support the entire system. For hybrid AC/DC microgrids, an attempted solution to the state estimation problem has conventionally involved decomposing the system into subsystems. In those existing methods, microgrids are modeled in the same way with the traditional distribution feeders, where a main grid or an infinite source is used to support the downstream system. Failure to represent the droop/secondary regulation may provide erroneous results when a microgrid is subjected to unenforceable disturbances.

### SUMMARY

Principles of the present invention, as manifested in one or more embodiments thereof, are directed to a system and method for performing enhanced quantum microgrid state estimation that addresses at least the above-noted problems with conventional (i.e., classical) state estimation approaches.

In accordance with an embodiment of the invention, a quantum computing-based method for performing enhanced state estimation for a microgrid system includes: obtaining a general quantum state estimation model for swing-bus-contained microgrid systems; establishing a state estimation formulation through quantum language; assigning a plurality of quantum registers for at least one of quantum encoding, binary representation of eigenvalues, and binary representation of electrical values during a quantum state estimation iteration; generating a quantum-circuit-based state estimation solver configured to perform quantum phase estimation, controlled rotation, and inverse quantum phase estimation; generating a preconditioned quantum linear solver for an ill-conditioned state estimation iteration; optimizing voltage and residual vectors iteratively, using a gradient descent rule, while iteratively updating preconditioned errors by the quantum-circuit-based state estimation solver, such optimizing and updating iterations continuing until the preconditioned quantum linear solver reaches convergence: obtaining a quantum state estimation model for hierarchical-based microgrid systems including at least one of droop and secondary control modes; establishing an enhanced quantum state estimation framework including the quantum-circuit-based state estimation solver and the preconditioned quantum linear solver for well-conditioned and ill-conditioned hierarchical-based microgrids, respectively; and utilizing the quantum-circuit-based state estimation solver to generate an enhanced state estimation output for controlling one or more parameters of the microgrid system.

In accordance with another embodiment of the invention, an apparatus for performing quantum microgrid state estimation in conjunction with a hierarchical control-based microgrid comprises a control module including at least one classical processor, and a quantum-circuit-based state estimation solver operatively coupled to the control module and including at least one quantum processing unit. The classical processor is configured to update a quantum computing model to obtain eigenvectors and corresponding coefficients of the eigenvectors of a gain matrix and cost function of the quantum computing model. The quantum processing unit is configured to perform quantum phase estimation, controlled rotation. and inverse quantum phase estimation. The quantum-circuit-based state estimation solver further includes a plurality of quantum registers for quantum encoding, binary representation of eigenvalues, and/or binary representation of electrical values during a quantum state estimation iteration.

In one or more embodiments, the quantum processing unit is configured: to generate a preconditioned quantum linear solver for an ill-conditioned state estimation iteration; to iteratively optimize voltage and residual vectors while iteratively updating preconditioned errors by the quantum-circuit-based state estimation solver, said optimizing and updating iterations continuing until the preconditioned quantum linear solver reaches convergence; to obtain a quantum state estimation model for hierarchical-based microgrid systems including at least one of droop and secondary control modes; to establish an enhanced quantum state estimation framework including the quantum-circuit-based state estimation solver and the preconditioned quantum linear solver for well-conditioned and ill-conditioned hierarchical-based microgrids, respectively: and to generate an enhanced state estimation output for controlling one or more parameters of the microgrid system.

In accordance with yet another embodiment of the invention, an apparatus for performing quantum state estimation for a microgrid system includes at least one classical processing unit configured to obtain a general quantum state estimation model for swing-bus-contained microgrid systems and to update the quantum state estimation model to obtain eigenvectors and corresponding coefficients of the eigenvectors of a gain matrix and cost function of the quantum state estimation model, and at least one quantum processing unit operatively coupled to the classical processing unit. The quantum processing unit is configured: to establish a state estimation formulation through quantum language; to assign a plurality of quantum registers for at least one of quantum encoding, binary representation of eigenvalues, and binary representation of electrical values during a quantum state estimation iteration; to generate a quantum-circuit-based state estimation solver configured to perform quantum phase estimation, controlled rotation, and inverse quantum phase estimation; to generate a preconditioned quantum linear solver for an ill-conditioned state estimation iteration; to iteratively optimize voltage and residual vectors while iteratively updating preconditioned errors by the quantum-circuit-based state estimation solver, said optimizing and updating iterations continuing until the preconditioned quantum linear solver reaches convergence; to obtain a quantum state estimation model for hierarchical-based microgrid systems including at least one of droop and secondary control modes; to establish an enhanced quantum state estimation framework including the quantum-circuit-based state estimation solver and the preconditioned quantum linear solver for well-conditioned and ill-conditioned hierarchical-based microgrids, respectively: and to utilize the quantum-circuit-based state estimation solver to generate an enhanced state estimation output for controlling one or more parameters of the microgrid system.

As the term may be used herein, “facilitating” an action contemplates performing the action, making the action easier, helping to carry out the action, or causing the action to be performed. Thus, by way of example only and without limitation, in the context of a processor-implemented method, instructions executing on one processor might facilitate an action carried out by instructions executing on a remote processor, by sending appropriate data or commands to cause or aid the action to be performed. For the avoidance of doubt, where an actor facilitates an action by other than directly performing the action itself, it is assumed that the action is nevertheless performed by some entity or combination of entities.

One or more embodiments of the invention or elements thereof may be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps.

Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. By way of example only and without limitation, a quantum microgrid state estimation system and method according to one or more embodiments of the invention may provide one or more of the following features, among other advantages:
utilizes quantum-circuit based algorithms that achieve exponential speedup in microgrid state estimation over traditional methodologies;
includes a preconditioned quantum linear solver (PQLS) for handling ill-conditioned general quantum state estimation (GQSE) with limited quantum resources; and
establishes an enhanced quantum state estimation (EQSE) algorithm for hierarchical control-based microgrids with exogenous disturbances.

These and other features and advantages of the present invention will become apparent from the following detailed description of illustrative embodiments thereof, which is to be read in connection with the accompanying drawings.

### BRIEF DESCRIPTION OF THE DRAWINGS

Non-limiting and non-exhaustive embodiments of the present invention will be described with reference to the following drawings which are presented by way of example only, wherein like reference numerals (when used) indicate corresponding elements throughout the several views unless otherwise specified, and wherein:

FIG. 1 is a block diagram depicting at least a portion of an exemplary architecture of a quantum-circuit-based general quantum state estimation (GQSE) algorithm, according to one or more embodiments of the present invention;

FIG. 2 depicts an exemplary enhanced quantum state estimation (EQSE) methodology suitable for performing DC microgrid state estimation, according to one or more embodiments of the present invention;

FIGS. 3A and 3B are block diagrams depicting at least portions of exemplary test system architectures for a two-bus DC microgrid system and a four-bus DC microgrid system, respectively, in which embodiments of the present invention can be utilized;

FIGS. 4A and 4B are graphs depicting exemplary voltage distributions of droop-based enhanced quantum state estimation (EQSE) against disturbances of N(0.01, 0.01²) and N (0.01, 0.05²), respectively, according to illustrative embodiments of the present invention;

FIGS. 5A and 5B are graphs depicting exemplary voltage distributions of secondary-based EQSE against disturbances of N(0.01, 0.01²) and N(0.01, 0.05²), respectively. according to illustrative embodiments of the present invention;

FIG. 6 is a bar graph depicting exemplary convergence performance results of EQSE according to embodiments of the present invention compared with classical state estimation (CSE); and

FIG. 7 is a block diagram depicting at least a portion of an exemplary computer system configurable for implementing at least a portion of one or more aspects and/or elements of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of the present invention, as manifested in one or more embodiments thereof, will be described herein in the context of an illustrative system, apparatus and/or method for direct current (DC) microgrid state estimation. It is to be appreciated, however, that the invention is not limited to the specific system, apparatus and/or methods illustratively shown and described herein. Rather, it will become apparent to those skilled in the art given the teachings herein that numerous modifications can be made to the embodiments shown that are within the scope of the claimed invention. For example, although the formulations described herein are presented in the context of a DC microgrid, it is to be appreciated that these formulations can be readily extended to alternating current (AC) microgrids and other hierarchical control-based microgrids as well. That is, no limitations with respect to the embodiments shown and described herein are intended or should be inferred.

A microgrid is a grouping of distributed energy resources (DERs) with control capabilities and can work in conjunction with the main/primary grid or operate autonomously as dictated by demand and/or other considerations (e.g., cost, etc.). It is essentially a smaller version of the grid with several distinct advantages. These advantages include the capability to operate when the main grid is down, a provision of stability in strengthening the grid by reducing grid disruptions, and an increase in efficiency due to the use of local energy sources which mitigate energy losses in the processes of transmission and distribution. Microgrids often use localized renewable energy sources for power generation (e.g., solar panel arrays, wind turbines, etc.), thus making them more environmentally friendly. A microgrid is mostly automated with smart technology and intelligent controls that can anticipate problems and failures and reconfigure itself to account for them.

As previously asserted, microgrid state estimation is an important aspect of energy management systems (EMS), primarily since it allows a system operator to control and monitor one or more parameters of an electric power system. The state of the power system can be estimated based on supervisory control and data acquisition (SCADA) measurements, phasor measurement unit (PMU) measurements, and/or other measurements known in the art. Some of the most important functions of EMS, such as, but not limited to, contingency analysis, optimal power flow, and security assessment, are based in large part on state estimation.

For modern microgrids, the demand for high-frequency state estimation is attributable to community expansion, a high penetration of uncertain renewables, and volatile operational conditions, among other factors. However, the complexities of conventional state estimation methods scale polynomially with the problem size, which makes those methods unsuitable for a future grid with formidable real-time operation requirements.

In order to address one or more problems associated with conventional microgrid state estimation, aspects of the present invention as described herein are directed to quantum-circuit-based algorithms for microgrid state estimation. In one or more embodiments, a general quantum state estimation (GQSE) formulation for swing-bus-constrained microgrids is devised through a quantized Gaussian-Newton iteration. To resolve the ill-conditioned matrix issue in GQSE, a preconditioned quantum linear solver (PQLS) is developed with limited quantum resources. Further, one or more embodiments of the invention establish an enhanced quantum state estimation (EQSE) algorithm for hierarchical-control-based microgrids with exogenous disturbances.

State estimation is an indispensable functionality in modern EMS for determining power system states with raw measurement data containing heterogeneous noises. A weighted least square can be used for state estimation. It minimizes the sum of weighted squared errors between measurements and estimated system states. The following equation gives a cost function of state estimation for a DC microgrid:

$$J ( V ) = {[ z - h ( V ) ]}^{T} {R}^{- 1} [ z - h ( V ) ] , \qquad ( 1 )$$

where V denotes a vector of per-unit unknown bus voltages (to be determined, and the initialized V is a vector where each element is one). h(V) is a vector containing the system states to be estimated. In this illustrative scenario, the estimated system states include three types of states, namely, power injections at unknown-voltage buses, branch powers at unknown-voltage buses, and unknown voltages. Mathematically, it can be expressed as follows:

$$h ( V ) = [ \begin{matrix}P ( V ) \\ {P}_{( g l )} ( V ) \\ V\end{matrix} ] = [ \begin{matrix}GV ∘ V \\ {V}_{( g )} ∘ {g}_{( g , l )} ∘ ( {V}_{( g )} - {V}_{( l )} ) \\ V\end{matrix} ] , \qquad ( 2 )$$

where P(V) is a vector of power injections at unknown-voltage buses. P_{(g,l)}(V) denotes the branch-power vector, V_{g} and Vₗ are from-bus-voltage and to-bus voltage vectors, respectively, G and g_{(g,l)} are the nodal conductance matrix and branch conductance vector of the DC microgrid, respectively, and ∘ represents a Hadamard product.

In equation (1) above, z is a vector containing the measured results of variables in h(V). R is the weight matrix (each element in R represents the coefficient for the corresponding element in [z−(V)]).

The Gauss-Newton algorithm can be applied to solving the nonlinear least square problem in equation (1). It performs the following iterations to obtain a minimal cost function:

$${H}^{T} {R}^{- 1} ( z - h ( {V}_{k - 1} ) ) = ( {H}^{T} {R}^{- 1} H ) Δ {V}_{k} , \qquad ( 3 )$$

where Vₖ₋₁ denotes the bus-voltage vector at the (k−1)^{th} iteration, ΔVₖ is a vector at the k^{th} iteration containing the difference between Vₖ and Vₖ₋₁, and H is a Jacobian matrix of h(Vₖ₋₁). Then, the bus-voltage vector Vₖ can be updated as Vₖ=Vₖ₋₁+ΔVₖ.

A major computation burden of the Gauss-Newton algorithm lies in equation (3) above, which involves the calculation of the gain matrix inverse; that is, (H^{T}R⁻¹H)⁻¹. Meanwhile, the gain matrix (H^{T}R⁻¹H) inherits the sparsity feature from the Jacobian matrix H and is strictly Hermitian. This allows the classical state estimation to be converted to a quantum formulation.

In the GQSE formulation, the Harrow-Hassidim-Lloyd (HHL) algorithm is utilized to handle equation (3) above to reduce computational complexity of the entire state estimation. For conciseness, the following derivations omit the subscript k. The classical formulation shown in equation (3) can be converted to a quantum computing model as follows:

$$\vert {H}^{T} {R}^{- 1} ( z - h ( V ) ) 〉 = ( {H}^{T} {R}^{- 1} H ) \vert Δ V 〉 , \qquad ( 4 )$$

where ΔV represents a difference of bus voltage vector between current iteration and previous one iteration, and |ΔV [symbol] is a normalized quantum state of ΔV. More particularly, the i^{th} component of ΔV corresponds to the amplitude of the i^{th} basis state of the quantum state |ΔV [symbol] . Similarly, |H^{T}R⁻¹(z−h(V)) [symbol] is a normalized quantum state of H^{T}R⁻¹(z−h(V)).

A primary objective of GQSE is to prepare a quantum superposition of ΔV, i.e., |ΔV [symbol] , on the quantum circuit, which satisfies equation (4). To achieve this, since H^{T}R⁻¹H is Hermitian, it has a spectral decomposition as follows:

$${H}^{T} {R}^{- 1} H = {\sum }_{j} {λ}_{j} {u}_{j} 〉 〈 {u}_{j} \vert , \qquad ( 5 )$$

where uⱼ) is the j^{th} eigenvector of H_{T}R⁻¹H with respective eigenvalue λⱼ. |H^{T}R⁻¹(z−h(V)) [symbol] can also be decomposed using the eigenvectors of H^{T}R⁻¹H as follows:

$$\vert {H}^{T} {R}^{- 1} ( z - h ( V ) ) 〉 = {\sum }_{j} {b}_{j} \vert {u}_{j} 〉 , \qquad ( 6 )$$

where bⱼ is the coefficient of eigenvector |uⱼ [symbol] .

Consequently, the quantum superposition of ΔV, i.e., |ΔV [symbol] , can be established from equations (4)-(6) above as follows:

$$\begin{matrix}\vert Δ V 〉 = {( {H}^{T} {R}^{- 1} H )}^{- 1} \vert {H}^{T} {R}^{- 1} ( z - h ( V ) ) 〉 \\ = ( {\sum }_{j} {λ}_{j}^{- 1} \vert {u}_{j} 〉 〈 {u}_{j} \vert ) ( {\sum }_{j} {b}_{j} \vert {u}_{j} 〉 ) \\ = {\sum }_{j} {λ}_{j}^{- 1} {b}_{j} \vert {u}_{j} 〉 .\end{matrix} \qquad ( 7 )$$

Equation (7) above allows the expression of |ΔV [symbol] using |uⱼ). A primary task is to establish a quantum circuit where λⱼ⁻¹ is combined with bⱼ|uⱼ [symbol] . In one or more embodiments, the quantum-circuit-based GQSE algorithm is developed to achieve this task, as described in further detail herein below.

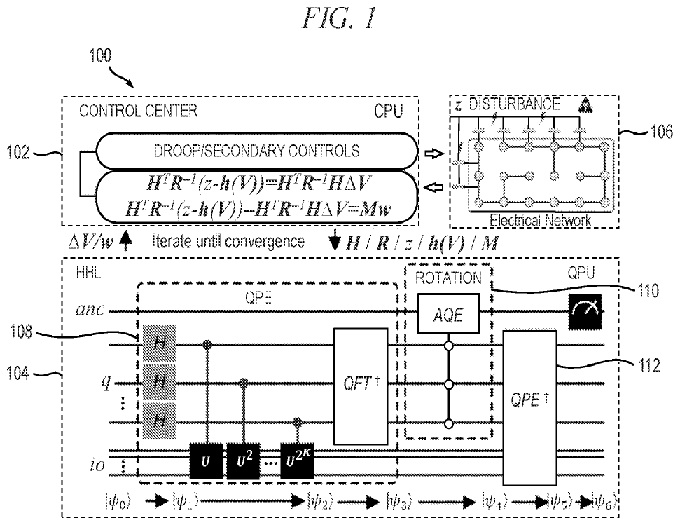

FIG. 1 is a block diagram depicting at least a portion of an exemplary architecture 100 for implementing a quantum-circuit-based GQSE algorithm, according to one or more embodiments of the invention. With reference to FIG. 1, the architecture 100 includes a control module or center 102, including at least one central processing unit (CPU), operatively coupled to an HHL quantum circuit 104, which together are configured to monitor disturbances 106 on an electrical network or microgrid. An overall idea of the GQSE algorithm is that raw data z, which is the vector containing measured results of variables in h(V), the vector containing the system states to be estimated, are measured and sent to the control center 102. The CPU in the control center 102 is configured to update H^{T}R⁻¹H and H^{T}R⁻¹(z−h(V)), using equations (5) and (6) above, to obtain |uⱼ [symbol] and bⱼ, respectively. This process is accomplished in at least one classical processor or computer (e.g., CPU), in one or more embodiments.

The HHL quantum circuit 104, which preferably includes at least one quantum processing unit (QPU), is then configured to obtain |ΔV [symbol] . In one or more embodiments, the HHL quantum circuit 104 includes three components: namely, a quantum phase estimation (QPE) module 108, a controlled rotation module 110, and an inverse QPE (QPE+) module 112. The input to the HHL quantum circuit 104 comprises a qubits for ancilla quantum encoding (AQE), denoted as anc, n qubits for the binary representation of λⱼ, denoted as q, and m qubits for the binary representation of bⱼ|uⱼ), denoted as i₀, as shown in FIG. 1, where a, n and m are integers. The initialized states of the qubits in anc and q are all zero. For in, the initialized states are bⱼ|uⱼ [symbol] (j=1, 2, . . . , m). In other words, the input of the HHL quantum circuit 104 can be represented as |ψ₀ [symbol] =|0 [symbol] ₙ⊗Σⱼbⱼ|uⱼ [symbol] ₘ⊗|0 [symbol] ₐ, where ⊗ refers to a tensor product.

The initialized quantum state |ψ₀ [symbol] is first handled by QPE. In one or more embodiments, the QPE module 108 comprises n Hadamard gates configured for generating quantum superpositions, n quantum unitary gates configured for obtaining a multi-qubit quantum state containing λⱼ, and an inverse quantum Fourier transformation (QFT) module, denoted QFT^{†}, configured for obtaining a reciprocal of each λⱼ, i.e., λⱼ⁻¹, λⱼ⁻¹ and bⱼ|uⱼ [symbol] are thus combined through the functions of the QPE module 108 and the controlled rotation module 110. The inverse QPE module 112 is further utilized to reset the state of each qubit in q and i₀, i.e., making the state of each qubit in q to be zero and that in i₀ as bⱼ|uⱼ [symbol] .

With continued reference to FIG. 1, the QPE module 108 aims to obtain λⱼ. Initially, n Hadamard gates are applied on n qubits in q, respectively, to create quantum superpositions. The quantum state (with all the qubits used) after all the Hadamard gates are applied (denoted as |ψ₁ [symbol] in FIG. 1), can be expressed as follows:

$$\begin{matrix}\vert {ψ}_{1} 〉 = {H}^{⊗ n} ⊗ {I}^{⊗ ( m + a )} \vert {ψ}_{0} 〉 \\ {{{= \frac{1}{\sqrt{{2}^{n}}} {\sum }_{α ∈ {\{ 0 , 1 \}}^{n}} \vert α 〉}_{n} {\sum }_{j} {b}_{j} \vert {u}_{j} 〉}_{m} \vert 0 〉}_{a} ,\end{matrix} \qquad ( 8 )$$

where H and I are the Hadamard and unit gates, respectively.

n quantum unitary gates, represented as U²^{^{k}} (where k=0, 1, . . . n−1), are then applied on the qubits in i₀ in series for obtaining a multi-qubit quantum state containing λⱼ. Specifically,

$${U}^{{2}^{k}} = {e}^{( i π {2}^{k + 1} {H}^{T} {R}^{- 1} H )} .$$

After unitary gates are applied, the quantum state (|ψ₂ [symbol] ) can be expressed as follows:

$$\begin{matrix}\vert {ψ}_{2} 〉 = {\prod }_{k = 0}^{n - 1} {U}^{{2}^{k}} ⊗ {I}^{⊗ a} \vert {ψ}_{1} 〉 \\ {{{= \frac{1}{{2}^{n / 2}} {\sum }_{χ = 0}^{{2}^{n} - 1} {e}^{( i 2 π {λ}_{j χ} )} \vert χ 〉}_{n} {\sum }_{j} {b}_{j} \vert {u}_{j} 〉}_{m} \vert 0 〉}_{a} .\end{matrix} \qquad ( 9 )$$

Inverse QFT is further applied to obtain each λⱼ. The quantum states after applying inverse QFT (|ψ₃ [symbol] ) can be represented as

$${{{\vert {ψ}_{3} 〉 = Q F {T}^{†} ⊗ {I}^{⊗ ( m + a )} \vert {ψ}_{2} 〉 = {\sum }_{j} {b}_{j} \vert {λ}_{j} 〉}_{n} \vert {u}_{j} 〉}_{m} \vert 0 〉}_{a} . \qquad ( 10 )$$

With continued reference to FIG. 1, the controlled rotation module 110 is configured to apply AQE to thereby obtain the reciprocal of each λⱼ, i.e., λⱼ⁻¹. The quantum state (|ψ₄ [symbol] ) than contains Σⱼλⱼ⁻¹bⱼ|uⱼ [symbol] ₘ, i.e., |ΔV [symbol] as in equation (7), as follows:

$$\vert {ψ}_{4} 〉 = AQE ⊗ {I}^{⊗ m} \vert {ψ}_{3} 〉$$

$${{{{= {\sum }_{j} {b}_{j} \vert {λ}_{j} 〉}_{n} \vert {u}_{j} 〉}_{m} ( \sqrt{1 - \frac{{β}^{2}}{{λ}_{f}^{2}}} \vert 0 〉}_{a} + \frac{β}{{λ}_{j}} \vert 1 〉}_{a} ) , \qquad ( 11 )$$

where β is a user-defined constant value.

Referring again to FIG. 1, the inverse QPE module 112 is utilized to reset the state of each qubit in q and i₀. After inverse quantum phase estimation is applied, the quantum state (|ψ₅ [symbol] ) can be expressed as follows:

$$\begin{matrix}\vert {ψ}_{5} 〉 = {QPE}^{†} ⊗ {I}^{⊗ a} \vert {ψ}_{4} 〉 \\ {{{{= \vert 0 〉}_{n} {\sum }_{j} {b}_{j} \vert {u}_{j} 〉}_{m} ( \sqrt{1 - \frac{{β}^{2}}{{λ}_{j}^{2}}} \vert 0 〉}_{a} + \frac{β}{{λ}_{j}} \vert 1 〉}_{a} ) .\end{matrix} \qquad ( 12 )$$

As shown in equation (12) above, once the measurement on anc is |1 [symbol] ₐ, the quantum state can be obtained as: |ψ₆ [symbol] =|0 [symbol] ₙ⊗|ΔV [symbol] ₘ⊗|1 [symbol] ₐ, where

$${{\vert Δ V 〉}_{m} = {\sum }_{j} {b}_{j} \frac{β}{{λ}_{j}} \vert {u}_{j} 〉}_{m}$$

(see equation (7)). The voltage vector V can thus be updated for the next iteration. The GQSE iterations continue until ΔV achieves convergence.

Although theoretically HHL offers an exponential speedup in terms of the system dimension, its efficiency can be affected by several factors. A computational complexity of HHL can be expressed as O(log(N)η²κ²), where N, η and κ denote the dimension, sparsity and condition number, respectively, of the gain matrix H^{T}R⁻¹H. While n does not vary much due to the sparse nature of power grids, κ can largely deviate in different systems. If an ill-conditioned gain matrix H^{T}R⁻¹H (where κ is extremely large) appears in GQSE, the efficiency of GQSE will be largely impacted. This is because a larger κ leads to a higher difference between the largest and the smallest eigenvalues, which makes the QPE in GQSE require more qubits to maintain the estimation accuracy. This inevitably leads to an increased quantum circuit depth and an over-compensation of qubit resources, which is undesirable.

To address this challenge, the present disclosure develops and provides a preconditioned quantum linear solver (PQLS). A primary objective of PQLS, according to one or more embodiments of the invention, is to use a preconditioned iterative optimization to obtain ΔV instead of directly calculating ΔV using equation (4) above. In other words, at each iteration in the Gauss-Newton algorithm (see equations (3) and (4)), ΔV is calculated by PQLS which utilizes an optimization process. Iteration procedures according to one or more embodiments are described below.

Multiple iterations are involved in PQLS. The symbol ξ is used to distinguish each iteration in PQLS with the iteration in the Gauss-Newton algorithm (denoted as κ in equation (3)), where ξ starts at 0, and ends when a convergence is reached. At the ξ^{th} iteration of PQLS, ΔV_{ξ+1} and the residual vector r_{ξ+1} (i.e., r_{ξ+1}=H^{T}R⁻¹(z−h (V))−(H^{T}R⁻¹H)ΔV_{ξ}, obtained from equation (3)) can be updated by using a gradient descent rule as follows:

$$\{ \begin{matrix}Δ {V}_{ξ + 1} = Δ {V}_{ξ} + {ρ}_{ξ} {p}_{ξ} \\ {r}_{ξ + 1} = {r}_{ξ} + {ρ}_{ξ} ( {H}^{T} {R}^{- 1} H ) {p}_{ξ} , ξ = 0 , 1 , …\end{matrix} \qquad ( 13 )$$

where the initialized ΔV_{ξ} and r_{ξ} (i.e., ΔV₀ and r₀) are 0and H^{T}R⁻¹(z−h(V))−(H^{T}R⁻¹H)ΔV₀, respectively. pr refers to the search direction and can be updated as follows:

$${p}_{ξ + 1} = {ξ + 1}_{} + {r}_{ξ + 1}^{T} {ξ + 1}_{} {( {r}_{ξ}^{T} {ξ}_{} )}^{- 1} {p}_{ξ} , \qquad ( 14 )$$

$$ξ = 0 , 1 , …$$

where [symbol] _{ξ} represents preconditioned errors. It can be calculated through quantum computing as follows:

$$\vert {r}_{ξ} 〉 = M \vert {ξ}_{} 〉 , \qquad ( 15 )$$

$$ξ = 0 , 1 , …$$

where M denotes a positive-definite, fixed preconditioner. An example of a commonly used preconditioner is the incomplete Cholesky factorization (see, e.g., P. Concus, et al., “Block Preconditioning for the Conjugate Gradient Method,” SIAM Journal on Scientific and Statistical Computing, vol. 6, no. 1, pp. 220-252, 1985, the disclosure of which is incorporated by reference herein in its entirety). [symbol] _{ξ} is initialized as follows:

$$\vert ( {H}^{T} {R}^{- 1} ( z - h ( V ) - {H}^{T} {R}^{- 1} H ) Δ {V}_{0} ) 〉 = M \vert {0}_{} 〉 . \qquad ( 16 )$$

p_{ξ} is initialized as p₀= [symbol] ₀, In equation (13), ρ_{ξ} is a coefficient, and can be obtained as ρ_{ξ}=r_{ξ}^{T} [symbol] _{ξ} (p_{ξ}^{T}H^{T}R⁻¹H_{pξ})⁻¹ (ξ=0, 1, . . . ).

The entire PQLS algorithm can be summarized as follows:
Step 1: Initialize ΔV₀, r₀, [symbol] ₀, and p₀.
Step 2: For each iteration, update ΔV_{ξ+1} and r_{ξ+1} using equation (13).
Step 3: If r_{ξ+1} reaches a tolerance of ϵ, output ΔV_{ξ+1}. Otherwise, update [symbol] _{ξ+1}, and p_{ξ+1} using equations (15) and (14), respectively.

In microgrids, hierarchical controls are applied on DERs to support power consumption and regulate bus voltages. A hierarchical control commonly consists of a droop control and a secondary control. For DC microgrids, an active power (P) and voltage (V), referred to as P/V, droop control can be applied to balance the power consumption. A main function of the secondary control, in one or more aspects of the invention, is to retrieve deviations of local voltages to their nominal values.

Conventional microgrid state estimation methods typically follow classical power flow formulations in equation (2), which however have ignored the features of hierarchical-control-based microgrids where multiple DERs, instead of a swing bus, support the entire system. Failure to represent the droop/secondary regulation may provide erroneous results when a microgrid is subjected to disturbances. Thus, embodiments of the invention, which utilize a novel EQSE algorithm, provide a beneficial improvement in the technical art of microgrid state estimation over conventional methodologies.

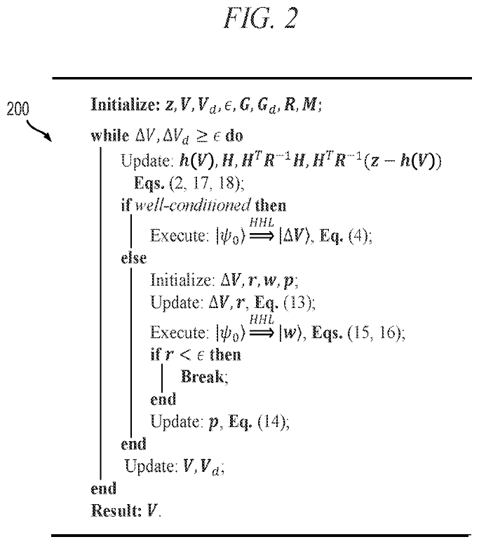

FIG. 2 depicts an exemplary EQSE methodology 200 suitable for use in a DC microgrid, according to one or more embodiments of the invention. The EQSE methodology 200 is a symbolic representation of the EQSE algorithm previously described herein, showing a correlation with equations (2, 4, and 13-18), as shown in FIG. 2. The EQSE methodology 200 incorporates either droop or (droop+secondary) control into h(V) to mitigate errors of state estimation results when the measurement z contains disturbances.

For droop-based EQSE, when only droop controls are applied in a microgrid, P(V) and the corresponding elements in the Jacobian matrix H (i.e.,

$$\frac{\partial P ( V )}{\partial V} )$$

can be devised as

$$\{ \begin{matrix}P ( V ) = GV ∘ V + {κ}_{G} ∘ ( {V}_{ref} - V ) \\ \frac{\partial P ( V )}{\partial V} = GV + {G}_{( diag )} V - {κ}_{G}\end{matrix} , \qquad ( 17 )$$

where G_{(diag)} is the diagonal part of G, κ_{G} is a vector containing the reciprocal of each P/V droop coefficient, and V_{ref} is the reference-voltage error.

For secondary-based EQSE, when both droop and secondary controls are applied in a microgrid, a dummy bus V_{d} can be added to calculate P(V) to assist the voltage recovery. Specifically, V_{d} can be designed as V_{d}=V*−V+V_{d}^{p}, where V is the unknown-voltage vector, V* is the rated-voltage vector, and V_{d}^{p} denotes the dummy-bus-voltage vector at the previous iteration. To be specific, it the element within (V*−V) is negative (or positive), the corresponding element in V_{d}^{p} will be added by a positive (or negative) deviation. With the dummy bus V_{d}, P(V) OP (V) and av can be expressed as

$$\{ \begin{matrix}P ( V ) = GV ∘ V + V ∘ ( {V}_{d} - V ) ∘ {G}_{d} \\ \frac{\partial P ( V )}{\partial V} = GV + {G}_{( diag )} V + ( {V}_{d} - 2 V ) ∘ {G}_{d}\end{matrix} , \qquad ( 18 )$$

where G_{d} is a vector containing the coefficients. At each iteration, V_{d} will be updated until the difference between V* and V reaches convergence.

It is to be understood that the aforementioned exemplary droop/secondary-based state estimation schemes according to embodiments of the invention are described in the context of DC microgrids by way of illustration only and without limitation or loss of generality. Nonetheless, the principles of EQSE according to embodiments of the invention are not limited to DC microgrids but rather are generic and can be readily applicable for AC microgrids as well, where hierarchical P/f and Q/V control schemes are adopted, as will become apparent to those skilled in the art given the teachings herein.

### Numerical Tests—Case Studies

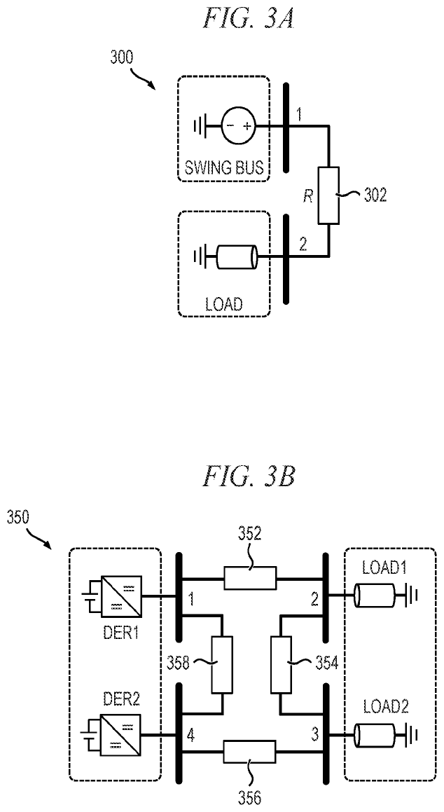

Several case studies were conducted for validating the correctness of GQSE, PQLS and EQSE in two typical illustrative microgrids; namely, a two-bus DC microgrid and a four-bus DC microgrid. Specifically, FIGS. 3A and 3B are block diagrams depicting at least portions of exemplary test system architectures for a two-bus DC microgrid system 300 and a four-bus DC microgrid system 350, respectively, in which embodiments of the invention can be utilized. With reference to FIG. 3A, the two-bus DC microgrid system 300 includes a first bus (Bus 1), which is a swing bus, and a second bus (Bus 2), which is a load bus, are operatively coupled together through a resistive element (R) 302. With reference to FIG. 3B, the four-bus DC microgrid system 350 includes a first bus (Bus 1), to which a first DER (DER1) is connected, a second bus (Bus 2), which is a first load bus (Load1), a third bus (Bus 3), which is a second load bus (Load2), and a fourth bus (Bus 4), to which a second DER (DER2) is connected. The Bus 1 and Bus 2 are operatively coupled together via a first impedance element 352, Bus 2 and Bus 3 are operatively coupled together via a second impedance element 354. Bus 3 and Bus 4 are operatively coupled together via a third impedance element 356, and Bus 1 and Bus 4 are operatively coupled together via a fourth impedance element 358.

The robustness and convergence performance of EQSE are verified as well. By way of example only and without limitation, all quantum algorithms are implemented in IBM's Qisket (version: 0.23.4), Terra (version: 0.16.3), and IBMQ provider (version: 0.11.1). The classical state estimation (CSE), i.e., the Gauss-Newton algorithm, is implemented in MATLAB® (a registered trademark of The Math Works, Inc.) running on a 2.5 GHz computer for comparison purposes.

The base voltage, i.e., the nominal rated voltage of the system, in this example is set at 400 V, and the base power is 1 KVA. In the two-bus microgrid system 300 shown in FIG. 3A, assume Bus 1 is a swing bus whose per-unit bus voltage is fixed at 1 per-unit (p.u.), and supports the power consumption of the entire system. In the four-bus microgrid system 350 shown in FIG. 3B, DERs 1 and 2 are connected with Buses 1 and 4, respectively. Assume that the P/V droop coefficients for DERs 1 and 2 are set at 1×10⁻⁵ and 2×10⁻⁴, respectively; each element in G_{d} (see equation (18)) for the secondary control is set at 20.

The correctness of GQSE in the 2-bus DC microgrid system and that of PQLS and EQSE in the 4-bus DC microgrid system will now be shown, using CSE as a comparison. Tables I and III below provide state estimation results of GQSE and PQSL (together with CSE comparisons) in the normal situation (i.e., without an ill-conditioned matrix), respectively. Table II below provides the state estimation results of GQSE with different numbers of qubits in q (see FIG. 1). Table IV presents the PQLS and CSE estimation results with an ill-conditioned matrix (i.e., the maximum eigenvalue: 9.4675×10¹⁰, and the minimum eigenvalue: 277.7778).

TABLE I
GQSE and CSE results in normal situation (p.u.)

| System | Iteration | V₁ (GQSE) | V₂ (GQSE) | V₁ (CSE) | V₂ (CSE) |
|---|---|---|---|---|---|
| 2-bus DC | 1 | 1.0000 | 0.9486 | 1.0000 | 0.9486 |
| microgrid | 2 | 1.0000 | 0.9473 | 1.0000 | 0.9472 |
| | 3 | 1.0000 | 0.9472 | 1.0000 | 0.9472 |

TABLE II
GQSE results in 1^{st} iteration with different
numbers of qubits in q (p.u.)

| Qubits in q | 2 | 4 | 6 | 10 | CSE |
|---|---|---|---|---|---|
| ΔV₁ | 0.0036 | 0.0006 | 0.0004 | 0.0000 | 0.0000 |
| ΔV₂ | −0.0242 | −0.0525 | −0.0508 | −0.0514 | −0.0514 |

TABLE III
PQLS and CSE results in the normal situation (p.u.)

| System | Method | Iteration | V₁ | V₂ | V₃ | V₄ |
|---|---|---|---|---|---|---|
| 4-bus DC | PQLS | 1 | 0.9999 | 0.9877 | 0.9884 | 0.9987 |
| microgrid | | 2 | 0.9999 | 0.9875 | 0.9882 | 0.9986 |
| (Droop) | | 3 | 0.9999 | 0.9875 | 0.9882 | 0.9986 |
| | CSE | 1 | 0.9999 | 0.9877 | 0.9884 | 0.9987 |
| | | 2 | 0.9999 | 0.9875 | 0.9882 | 0.9986 |
| | | 3 | 0.9999 | 0.9875 | 0.9882 | 0.9986 |
| 4-bus DC | PQLS | 1 | 0.9999 | 0.9880 | 0.9892 | 0.9999 |
| microgrid | | 2 | 1.0003 | 0.9884 | 0.9895 | 1.0003 |
| (Secondary) | | 3 | 1.0003 | 0.9884 | 0.9895 | 1.0003 |
| | CSE | 1 | 0.9999 | 0.9880 | 0.9892 | 0.9999 |
| | | 2 | 1.0003 | 0.9884 | 0.9895 | 1.0003 |
| | | 3 | 1.0003 | 0.9884 | 0.9895 | 1.0003 |

TABLE IV
GQSE, PQLS and CSE results with an ill-conditioned matrix (p.u.)

| Algorithm | Iteration | ΔV₁ | ΔV₂ | ΔV₃ | ΔV₄ |
|---|---|---|---|---|---|
| GQSE | — | 0.0065 | −0.0060 | −0.0055 | 0.0049 |
| PQLS | 1 | 0.0062 | −0.0060 | −0.0052 | 0.0050 |
| | 2 | 0.0062 | −0.0060 | −0.0052 | 0.0049 |
| | 3 | 0.0001 | −0.0124 | −0.0116 | 0.0013 |
| | 4 | 0.0001 | −0.0123 | −0.0116 | 0.0013 |
| | 5 | 0.0001 | −0.0123 | −0.0116 | 0.0013 |
| | 6 | 0.0001 | −0.0123 | −0.0116 | 0.0013 |
| CSE | — | 0.0001 | −0.0123 | −0.0116 | 0.0013 |

TABLE V
EQSE and ESE results (p.u.)

| System | Method | Iteration | V₁ | V₂ | V₃ | V₄ |
|---|---|---|---|---|---|---|
| 4-bus DC | EQSE | 1 | 0.9999 | 0.9876 | 0.9884 | 0.9986 |
| microgrid | | 2 | 0.9999 | 0.9875 | 0.9883 | 0.9986 |
| (Droop) | | 3 | 0.9999 | 0.9875 | 0.9883 | 0.9986 |
| | ESE | 1 | 0.9999 | 0.9876 | 0.9884 | 0.9986 |
| | | 2 | 0.9999 | 0.9875 | 0.9883 | 0.9986 |
| | | 3 | 0.9999 | 0.9875 | 0.9883 | 0.9986 |
| 4-bus DC | EQSE | 1 | 1.0435 | 1.0317 | 1.0329 | 1.0437 |
| microgrid | | 2 | 1.0018 | 0.9899 | 0.9912 | 1.0020 |
| (Secondary) | | 3 | 0.9983 | 0.9864 | 0.9877 | 0.9986 |
| | | 4 | 0.9998 | 0.9879 | 0.9892 | 1.0001 |
| | | 5 | 0.9999 | 0.9880 | 0.9893 | 1.0001 |
| | ESE | 1 | 1.0435 | 1.0317 | 1.0329 | 1.0437 |
| | | 2 | 1.0018 | 0.9899 | 0.9912 | 1.0020 |
| | | 3 | 0.9983 | 0.9864 | 0.9877 | 0.9986 |
| | | 4 | 0.9998 | 0.9879 | 0.9892 | 1.0001 |
| | | 5 | 0.9999 | 0.9880 | 0.9893 | 1.0001 |

For EQSE, an enhanced state estimation (ESE) method is utilized for comparison. Specifically, ESE has the same principle as EQSE except that the quantum procedures in EQSE are replaced with classical operations. Table V shows the comparison results of EQSE and ESE under droop control and droop plus secondary control. From Tables I-V above, the following insights can be obtained:
(i) The estimation results from GQSE (i.e., after the third iteration) and CSE are exactly the same (see Table I), which validates the correctness of GQSE.
(ii) For GQSE, having a sufficient number of qubits in q is critical to achieve an accurate estimation result. As shown in Table II, increasing the number of qubits in q can greatly improve accuracy of the GQSE result, i.e., the result obtained from GQSE is closer to the CSE result. This is primarily because more precise eigenvalues of H^{T}R⁻¹H can be obtained with more qubits in q.
(iii) Tables III and IV validate the correctness of PQLS in the normal situation and with an ill-conditioned matrix, respectively. Results show that although H^{T}R⁻¹H is ill-conditioned, the PQLS-based QSE still possesses excellent convergence by adjusting the preconditioning errors to eventually achieve accurate results.
(iv) Table V validates the correctness of EQSE, i.e., the results obtained from EQSE are exactly the same with those from ESE in both droop and secondary controls.

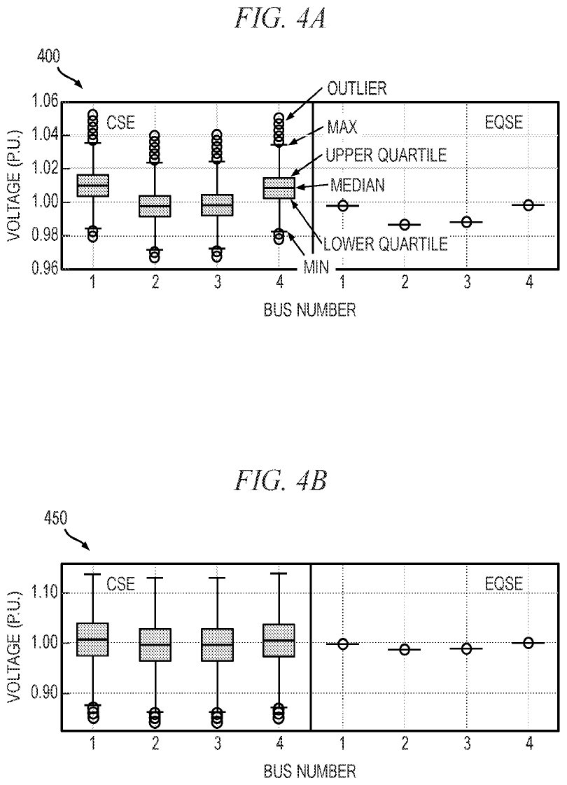

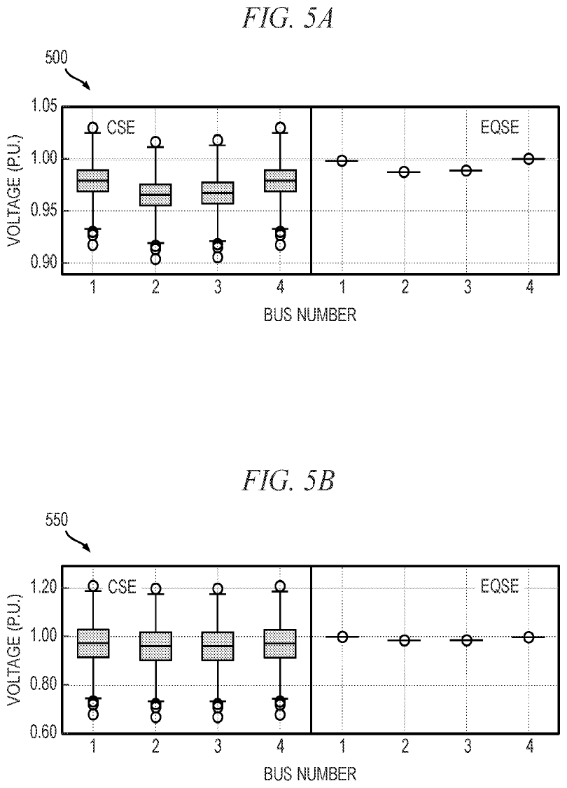

The robustness of EQSE against disturbances will now be discussed. Disturbances are assumed to follow a Gaussian distribution with N(μ, σ²). More particularly, by way of illustration only and without limitation, 100 samples of disturbances are generated based on the distribution of N(0.01, 0.01²). These disturbances are then added to the measurement z, respectively. For each disturbance, EQSE and CSE are used to conduct the state estimation using the updated z (with the disturbance), respectively. Similarly, another 100 samples with the distribution of N(0.01, 0.05²) are applied. The voltage distributions in droop-based and secondary-based EQSE and CSE under the two distributions are shown in FIGS. 4A-B and 5A-B, respectively, where the outlier, maximum, upper quartile, median, lower quartile, and minimum voltages are presented. Specifically, FIGS. 4A and 4B are graphs 400 and 450 depicting exemplary voltage distributions of droop-based EQSE against disturbances of N(0.01, 0.01²) and N(0.01, 0.05²), respectively, according to illustrative embodiments of the invention. Likewise, FIGS. 5A and 5B are graphs 500 and 550 depicting exemplary voltage distributions of secondary-based EQSE against disturbances of N(0.01, 0.01²) and N (0.01, 0.05²), respectively, according to embodiments of the invention. Table VI below presents the average voltages and variances (from all the 100 samples) of droop-based and secondary-based EQSE and CSE.

TABLE VI
Average EQSE and CSE results with disturbances (p.u.)

| | Bus | N(0, 0²) | N(0.01, 0.01²) | N(0.01, 0.05²) |
|---|---|---|---|---|
| Control | Num | EQSE & CSE | EQSE/CSE | EQSE/CSE |
| Droop | V₁ | 0.9999 | 0.9980/1.0098 | 0.9979/1.0110 |
| | V₂ | 0.9875 | 0.9865/0.9976 | 0.9865/0.9987 |
| | V₃ | 0.9883 | 0.9878/0.9983 | 0.9878/0.9994 |
| | V₄ | 0.9986 | 0.9980/1.0085 | 0.9980/1.0097 |
| Variance | | — | 5.43e−6/1.26e−5 | 5.55e−6/1.04e−2 |
| Secondary | | 1.0000 | 09998/0.9986 | 0.9998/0.9841 |
| | V₂ | 0.9884 | 0.9877/1.0016 | 0.9879/0.9719 |
| | V₃ | 0.9896 | 0.9894/1.0028 | 0.9891/0.9731 |
| | V₄ | 1.0000 | 1.0001/1.0135 | 0.9999/0.9841 |

| | | | |
|---|---|---|---|
| Variance | — | 9.75e−4/3.82e−3 | 1.01e−3/5.20e−3 |

The results in Table VI demonstrate the superior performance achieved using EQSE according to embodiments of the invention. Specifically, from Table VI the following observations can be perceived:
(i) The droop-based EQSE outperforms CSE in terms of the robustness against disturbances. For instance. in FIG. 4A, the voltage distributions of EQSE under the disturbance of N(0.01, 0.01²) are much narrower than those of CSE. When the disturbance has a distribution of N(0.01, 0.05²) (see FIG. 4B), the voltage variations of CSE become larger, while those of EQSE remain small. This is primarily because CSE relies on a swing bus to balance the disturbances, while EQSE according to embodiments of the invention redistributes the disturbances into multiple DERs. FIGS. 5A-B show that the secondary-based EQSE is also robust against disturbances.
(ii) Table VI further validates the robustness of both droop-based and secondary-based EQSE under disturbances. For instance, when the disturbance has a distribution of N(0.01, 0.01²), for CSE under secondary control, V₁ becomes 0.9986 p.u., which largely deviates from the value with no disturbance, i.e., 1.0000 p.u. under N(0, 0²). By comparison, for EQSE, V₁ remains 0.9998 p.u., i.e., a value much closer to 1.0000 p.u. This becomes more apparent when the disturbance has a distribution of N(0.01, 0.05²).

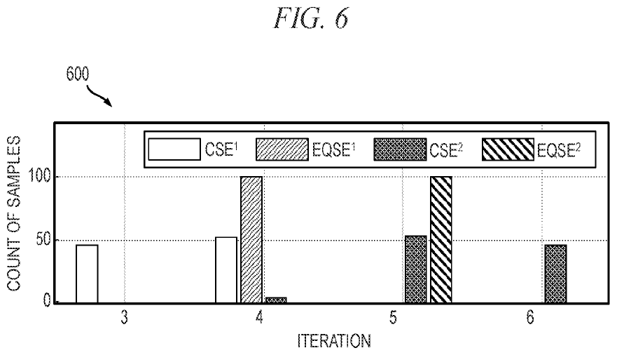

In terms of convergence, EQSE according to embodiments of the invention also provides superior performance results. By way of example only and without limitation, for both EQSE and CSE, under each disturbance (from 100 samples with N(0.01, 0.01²)), the required number of iterations for producing the final result is recorded, in droop-based and secondary-based systems, respectively. FIG. 6 is a bar graph 600 visually depicting exemplary convergence performance results of EQSE according to embodiments of the invention compared with CSE. With reference to FIG. 6, the following insights are obtained:
(i) For either droop-based or secondary-based EQSE, the required number of iterations has a similar level with that of CSE. For instance, all the recorded numbers of iterations for the droop-based EQSE are 4 (see EQSE¹ in FIG. 6), while those for CSE are either 3 or 4 (see CSE¹ in FIG. 6).
(ii) The convergence performance of EQSE is less likely to be affected by disturbances than that of CSE. For instance, in FIG. 6, all the recorded numbers of iterations for the droop-based EQSE are 4 (see EQSE¹ is FIG. 6) and those for the secondary-based EQSE are 5 (see EQSE² in FIG. 6). However, those for CSE are distributed (see CSE¹ and CSE² in FIG. 6).

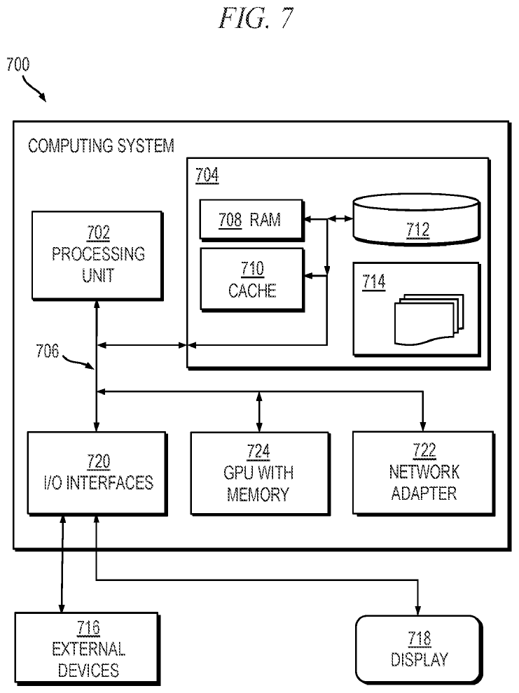

FIG. 7 is a block diagram depicting at least a portion of an exemplary computing system 700 configurable for implementing at least a portion of one or more methods of the invention described herein. The computing system 700 is only one example of a suitable computer system and is not intended to limit the scope of use or functionality of embodiments of the invention described herein. In the computing system 700. there are components, which are operational with numerous other general purpose or special purpose computing system environments or configurations. Examples of well-known computing systems, environments, and/or configurations that may be suitable for use with the computing system 700 include, but are not limited to, quantum computing systems, personal computer systems, server computer systems, thin clients, thick clients, hand-held or laptop devices, multiprocessor systems, microprocessor-based systems, distributed computing systems, programmable consumer electronics, network PCs, minicomputer systems, mainframe computer systems, and distributed cloud computing environments that include any of the above systems or devices, and the like.

The computing system 700 may be described in the general context of computer system-executable instructions, such as program modules, being executed by one or more processors. Generally, program modules may include routines, programs, objects, components, logic, data structures. and so on that perform particular tasks or implement particular abstract data types. The computing system 700 may be practiced in a distributed cloud computing environment where tasks are performed by remote processing devices that are linked through a communications network. In a distributed cloud computing environment, program modules may be located in both local and remote computer system storage media, including memory storage devices.

As shown in FIG. 7, the computing system 700 is shown in the form of a general-purpose computing device. Components of the computing system 700 may include, but are not limited to, one or more processors or processing units 702, a system memory 704, and a bus 706 that operatively couples various system components including system memory 704 to the processor 702. Bus 706 represents one or more of any of several types of bus structures, including a memory bus or memory controller, a peripheral bus. an accelerated graphics port, and a processor or local bus using any of a variety of bus architectures. By way of example only and without limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The computing system 700 typically includes a variety of computer system readable media. Such media may be any available media that is accessible by the computing system 700, and it includes both, volatile and non-volatile media, removable and non-removable media.

The system memory 704 may include computer system readable media in the form of volatile memory, such as random access memory (RAM) 708 and/or cache memory 710. The computing system 700 may further include other removable/non-removable, volatile/non-volatile computer system storage media. By way of example only, a storage system 712 may be provided for reading from and writing to a non-removable, non-volatile magnetic media (not shown and typically called a “hard drive”). Although not explicitly shown, a magnetic disk drive for reading from and writing to a removable, non-volatile magnetic disk (e.g., a “floppy disk”), an optical disk drive for reading from or writing to a removable, non-volatile optical disk such as a CD-ROM, DVD-ROM or other optical media, and/or a solid-state drive (SSD) may be provided. In such instances, each can be connected to the bus 706 by one or more data media interfaces. As will be further depicted and described below, memory 704 may include at least one program product having a set (e.g., at least one) of program modules 714 that are configured to carry out one or more functions according to embodiments of the invention.

The program/utility, having a set (at least one) of program modules 714, may be stored in memory 704 by way of example, and not limiting, as well as an operating system, one or more application programs, other program modules, and program data. Each of the operating systems, one or more application programs, other program modules, and program data or some combination thereof, may include an implementation of a networking environment. Program modules 714 generally carry out the functions and/or methodologies of embodiments of the invention, as described herein.

The computing system 700 may also communicate with one or more external devices 716 such as a keyboard, a pointing device, a display 718, etc.; one or more devices that enable a user to interact with the computing system 700; and/or any devices (e.g., network card. modem, etc.) that enable the computing system 700 to communicate with one or more other computing devices. Such communications can occur via input/output (I/O) interfaces 720. Still yet, the computing system 700 may communicate with one or more networks, such as a local area network (LAN), a general wide area network (WAN), and/or a public network (e.g., the Internet), via a network adapter 722. As depicted, the network adapter 722 may communicate with the other components of the computing system 700 via bus 706. It should be understood that although not explicitly shown, other hardware and/or software components could be used in conjunction with the computing system 700. Examples, include, but are not limited to, microcode, device drivers, redundant processing units, external disk drive arrays, RAID systems, tape drives, and data archival storage systems, etc.

The processing unit 702 in the computing system 700 may communicate with one or more other processors, such as a general processing unit (GPU) 724, via the bus 706, such as in a distributed computing arrangement. The GPU 724 may include its own internal memory for at least temporarily storing intermediate processing results, program instructions, etc. The GPU 724 may also be configured to communicate with the one or more external devices 716 via the I/O interface 720 or with the one or more networks via the network adapter 722.

The descriptions of the various embodiments of the present invention have been presented for purposes of illustration, but are not intended to be exhaustive or limited to the embodiments disclosed. Many modifications and variations will be apparent to those of ordinary skills in the art given the teachings herein without departing from the scope and spirit of the described embodiments. The terminology used herein was chosen to best explain the principles of the embodiments, the practical application or technical improvement over conventional technologies, or to enable others of ordinary skill in the art to understand the embodiments disclosed herein.

The present invention may be embodied as a system, a method, and/or a computer program product. The computer program product may include a non-transitory computer readable storage medium (or media) having computer readable program instructions thereon for causing a processor to carry out aspects of the present invention.

The non-transitory storage medium may be an electronic, magnetic, optical, electromagnetic, infrared or a semi-conductor system for a propagation medium. Examples of a computer-readable medium may include a semiconductor or solid-state memory, magnetic tape, a removable computer diskette, a random access memory (RAM), a read-only memory (ROM), a rigid magnetic disk, a flash drive, and an optical disk. Current examples of optical disks include compact disk-read only memory (CD-ROM), compact disk-read/write (CD-R/W), digital versatile disk (DVD), Blu-Ray Disk, etc.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls. switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions. machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood by those skilled in the art that each block of the flowchart illustrations and/or block diagrams. and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another devices to cause a series of operational steps to be performed on the computer, other programmable apparatus or other device to produce a computer implemented process, such that the instructions which execute on the computer, other programmable apparatus, or another device implement the functions/acts specified in the flowchart and/or block diagram block or blocks.

The flowcharts and/or block diagrams in the Figures illustrate the architecture, functionality, and/or operation of possible implementations of systems, methods, and computer program products according to one or more embodiments of the present invention. In this regard, each block in the flowchart or block diagrams, or each program code line in an illustrated algorithm, may represent a module, segment, or portion of instructions, which comprises one or more executable instructions for implementing the specified function(s). In some alternative implementations, the functions noted in the block may occur out of the order noted in the figures. For example, two blocks shown in succession may, in fact, be executed substantially concurrently. or the blocks may sometimes be executed in the reverse order, depending upon the functionality involved. It will also be appreciated that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

At least a portion of the techniques of the present invention may be implemented in an integrated circuit. In forming integrated circuits, identical die are typically fabricated in a repeated pattern on a surface of a semiconductor wafer. Each die includes a device described herein, and may include other elements, structures and/or circuits. The individual die are cut or diced from the wafer, then packaged as an integrated circuit. One skilled in the art would know how to dice wafers and package die to produce integrated circuits. Any of the exemplary systems and circuits illustrated in the accompanying figures, or portions thereof, may be part of an integrated circuit. Integrated circuits so manufactured are considered part of this invention.

Those skilled in the art will appreciate that the exemplary systems and circuits discussed above, or portions thereof, can be distributed in raw form (i.e., a single wafer having multiple unpackaged chips), as bare dies, in packaged form, or incorporated as parts of intermediate products or end products that benefit from having a microgrid controller formed therein in accordance with one or more embodiments of the invention, such as, for example, an SDC microgrid control system.

An integrated circuit in accordance with aspects of the present disclosure can be employed in essentially any microgrid control application and/or electronic system. Systems incorporating such integrated circuits are considered part of this invention. Given the teachings of the present disclosure provided herein, one of ordinary skill in the art will be able to contemplate other implementations and applications of embodiments of the invention.

The illustrations of embodiments of the invention described herein are intended to provide a general understanding of the various embodiments and are not intended to serve as a complete description of all the elements and features of apparatus and systems that might make use of the module, circuits and/or methods described herein. Many other embodiments will become apparent to those skilled in the art given the teachings herein; other embodiments are utilized and derived therefrom, such that structural and logical substitutions and changes can be made without departing from the scope of this disclosure. The drawings are also merely representational and are not drawn to scale. Accordingly, the specification and drawings are to be regarded in an illustrative rather than a restrictive sense.

Embodiments of the invention are referred to herein, individually and/or collectively, by the term “embodiment” merely for convenience and without intending to limit the scope of this application to any single embodiment or inventive concept if more than one is, in fact, shown. Thus, although specific embodiments have been illustrated and described herein, it should be understood that an arrangement achieving the same purpose can be substituted for the specific embodiment(s) shown; that is, this disclosure is intended to cover any and all adaptations or variations of various embodiments. Combinations of the above embodiments, and other embodiments not specifically described herein, will become apparent to those of skill in the art given the teachings herein.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Locational terms such as “above,” “below,” “in,” “out,” “internal,” and “external,” as may be used herein, are intended to describe the relative position of elements or structures to each other as opposed to an absolute position of the elements or structures.

The corresponding structures, materials, acts, and equivalents of all means or step-plus-function elements in the claims below are intended to include any structure, material, or act for performing the function in combination with other claimed elements as specifically claimed. The description of the various embodiments has been presented for purposes of illustration and description, but is not intended to be exhaustive or limited to the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the various embodiments with various modifications as are suited to the particular use contemplated.

The abstract is provided to comply with 37 C.F.R. § 1.72 (b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the appended claims reflect, inventive subject matter lies in less than all features of a single embodiment. Thus, the following claims are hereby incorporated into the Detailed Description, with each claim standing on its own as separately claimed subject matter.

Given the teachings of embodiments of the invention provided herein, one of ordinary skill in the art will be able to contemplate other implementations and applications of the techniques of embodiments of the invention. Although illustrative embodiments of the invention have been described herein with reference to the accompanying drawings, it is to be understood that embodiments of the invention are not limited to those precise embodiments, and that various other changes and modifications are made therein by one skilled in the art without departing from the scope of the appended claims.

1. A quantum computing-based method of performing enhanced state estimation for a microgrid system, the method comprising:
obtaining a general quantum state estimation model for swing-bus-contained microgrid systems;
establishing a state estimation formulation through quantum language;
assigning a plurality of quantum registers for at least one of quantum encoding, binary representation of eigenvalues, and binary representation of electrical values during a quantum state estimation iteration;
generating a quantum-circuit-based state estimation solver configured to perform quantum phase estimation, controlled rotation, and inverse quantum phase estimation;
generating a preconditioned quantum linear solver for an ill-conditioned state estimation iteration;
iteratively optimizing voltage and residual vectors while iteratively updating preconditioned errors by the quantum-circuit-based state estimation solver, the optimizing and updating iterations continuing until the preconditioned quantum linear solver reaches convergence;
obtaining a quantum state estimation model for hierarchical-based microgrid systems including at least one of droop and secondary control modes;
establishing an enhanced quantum state estimation framework including the quantum-circuit-based state estimation solver and the preconditioned quantum linear solver for well-conditioned and ill-conditioned hierarchical-based microgrids, respectively; and
utilizing the quantum-circuit-based state estimation solver to generate an enhanced state estimation output for controlling one or more parameters of the microgrid system.

2. The method according to claim 1, wherein generating the preconditioned quantum linear solver is performed using incomplete Cholesky factorization.

3. The method according to claim 1, wherein assigning the plurality of quantum registers comprises initializing three quantum registers, the three quantum registers being configured for quantum encoding, binary representation of eigenvalues, and binary representation of electrical values, respectively.

4. The method according to claim 1, wherein generating the preconditioned quantum linear solver comprises:
initializing ΔV₀, r₀, [symbol] ₀, and p₀, where ΔV₀ represents a difference voltage vector at iteration zero, r₀ represents a residual vector at iteration zero, [symbol] ₀ represents a preconditioned error at iteration zero, and p₀ refers to a search direction at iteration zero;
for each iteration, updating ΔV_{ξ+1} and r_{ξ+1} using an expression
$$\{ \begin{matrix}Δ {V}_{ξ + 1} = Δ {V}_{ξ} + {ρ}_{ξ} {p}_{ξ} \\ {r}_{ξ + 1} = {r}_{ξ} + {ρ}_{ξ} ( {H}^{T} {R}^{- 1} H ) {p}_{ξ} , ξ = 0 , 1 , …\end{matrix} ,$$
where ξ is an integer representing a preconditioned quantum linear solver iteration number, ρ_{ξ} is a coefficient, and H^{T}R⁻¹H is a gain matrix; and
when r_{ξ+1} reaches a prescribed tolerance of ϵ, outputting ΔV_{ξ+1}, otherwise updating [symbol] _{ξ+1}, and p_{ξ+1} using expressions
$$\vert {r}_{ξ} 〉 = M \vert {ξ}_{} 〉$$
$$and$$
$${p}_{ξ + 1} = {ξ + 1}_{} + {r}_{ξ + 1}^{T} {ξ + 1}_{} {( {r}_{ξ}^{T} {ξ}_{} )}^{- 1} {p}_{ξ} ( ξ = 0 , 1 , … ) ,$$
respectively.

5. The method according to claim 1, further comprising incorporating at least one of droop and secondary controls into a vector, h(V), containing microgrid system states to be estimated, using enhanced quantum state estimation (EQSE).

6. The method according to claim 5, wherein when only droop controls are applied in the microgrid system, EQSE is configured to devise a vector of power injections at unknown-voltage buses, P(V), and corresponding elements in a Jacobian matrix, ∂P(V)/∂V, as follows: <CWU-Call number
$$\{ \begin{matrix}P ( V ) = GV ∘ V + {κ}_{G} ∘ ( {V}_{ref} - V ) \\ \frac{\partial P ( V )}{\partial V} = GV + {G}_{( diag )} V - {κ}_{G}\end{matrix} ,$$
where G_{(diag)} is a diagonal part of a nodal conductance matrix, G, of the microgrid system, κ_{G} is a vector containing a reciprocal of each power and voltage droop coefficient, and V_{ref} is a reference-voltage error.

7. The method according to claim 5, wherein when both droop and secondary controls are applied in the microgrid system, the method comprises assisting voltage recovery by adding a dummy bus, V_{d}, to determine a vector of power injections at unknown-voltage buses, P(V), as V_{d}=V*−V+V_{d}^{p}, where V is an unknown-voltage vector, V* is a rated-voltage vector, and V_{d}^{p} denotes the dummy bus voltage vector at a previous iteration.

8. The method according to claim 7, wherein at each iteration, V_{d} is updated until a difference between V* and V reaches convergence.

9. The method according to claim 1, wherein the quantum-circuit-based state estimation solver comprises a Harrow-Hassidim-Lloyd (HHL)-based state estimation solver.

10. The method according to claim 1, wherein iteratively optimizing the voltage and residual vectors is performed using a gradient descent rule.

11. A quantum computing-based apparatus to perform enhanced state estimation for a microgrid system, the apparatus comprising:
a control module including at least one classical processor configured to update a quantum computing model to obtain eigenvectors and corresponding coefficients of the eigenvectors of a gain matrix and cost function of the quantum computing model; and
a quantum-circuit-based state estimation solver operatively coupled to the control module, the quantum-circuit-based state estimation solver comprising at least one quantum processing unit configured to perform quantum phase estimation, controlled rotation, and inverse quantum phase estimation, the quantum-circuit-based state estimation solver further comprising a plurality of quantum registers for at least one of quantum encoding, binary representation of eigenvalues, and binary representation of electrical values during a quantum state estimation iteration;
wherein the at least one quantum processing unit is configured to: generate a preconditioned quantum linear solver for an ill-conditioned state estimation iteration; iteratively optimize voltage and residual vectors while iteratively updating preconditioned errors by the quantum-circuit-based state estimation solver, the optimizing and updating iterations continuing until the preconditioned quantum linear solver reaches convergence; obtain a quantum state estimation model for hierarchical-based microgrid systems including at least one of droop and secondary control modes; establish an enhanced quantum state estimation framework including the quantum-circuit-based state estimation solver and the preconditioned quantum linear solver for well-conditioned and ill-conditioned hierarchical-based microgrids, respectively; and generate an enhanced state estimation output for controlling one or more parameters of the microgrid system.

12. The apparatus according to claim 11, wherein the preconditioned quantum linear solver is configured to performed incomplete Cholesky factorization.

13. The apparatus according to claim 11, wherein the preconditioned quantum linear solver is configured to:
initialize ΔV₀, r₀, [symbol] ₀, and p₀, where ΔV₀ represents a difference voltage vector at iteration zero, ro represents the residual vector at iteration zero, [symbol] ₀ represents preconditioned error at iteration zero, and p₀ refers to search direction at iteration zero;
for each iteration, update ΔV_{ξ+1} and r_{ξ+1} using the expression
$$\{ \begin{matrix}Δ {V}_{ξ + 1} = Δ {V}_{ξ} + {ρ}_{ξ} {p}_{ξ} \\ {r}_{ξ + 1} = {r}_{ξ} + {ρ}_{ξ} ( {H}^{T} {R}^{- 1} H ) {p}_{ξ} , ξ = 0 , 1 , …\end{matrix} ,$$
where τ is an integer representing a preconditioned quantum linear solver iteration number, ρ_{ξ} is a coefficient, and H^{T}R⁻¹H is a gain matrix; and
when r_{ξ+1} reaches a prescribed tolerance of ϵ, to output ΔV_{ξ+1}, otherwise to update [symbol] _{ξ+1}, and p_{ξ+1} using expressions
$$\vert {r}_{ξ} 〉 = M \vert {ξ}_{} 〉$$
$$and$$
$${p}_{ξ + 1} = {ξ + 1}_{} + {r}_{ξ + 1}^{T} {ξ + 1}_{} {( {r}_{ξ}^{T} {ξ}_{} )}^{- 1} {p}_{ξ} ( ξ = 0 , 1 , … ) ,$$
respectively.

14. The apparatus according to claim 11, wherein the quantum-circuit-based state estimation solver is configured to incorporate at least one of droop and secondary controls into a vector, h(V), containing microgrid system states to be estimated, using enhanced quantum state estimation (EQSE).

15. The apparatus according to claim 14, wherein when only droop controls are applied in the microgrid system, EQSE comprises devising a vector of power injections at unknown-voltage buses, P(V), and corresponding elements in a Jacobian matrix, ∂P(V)/∂V, as follows:
$$\{ \begin{matrix}P ( V ) = GV ∘ V + {κ}_{G} ∘ ( {V}_{ref} - V ) \\ \frac{\partial P ( V )}{\partial V} = GV + {G}_{( diag )} V - {κ}_{G}\end{matrix} ,$$
where G_{(diag)} is a diagonal part of a nodal conductance matrix, G, of the microgrid system, κ_{G} is a vector containing a reciprocal of each power and voltage droop coefficient, and V_{ref} is a reference-voltage vector.

16. The apparatus according to claim 14, wherein when both droop and secondary controls are applied in the microgrid system, the quantum-circuit-based state estimation solver is configured to assist voltage recovery by adding a dummy bus, V_{d}, to determine a vector of power injections at unknown-voltage buses, P(V), as V_{d}=V*−V+V_{d}^{p}, where V is an unknown-voltage vector, V* is a rated-voltage vector, and V_{d}^{p} denotes the dummy bus voltage vector at a previous iteration.

17. The apparatus according to claim 16, wherein at each iteration, V_{d} is updated until a difference between V* and V reaches convergence.

18. The apparatus according to claim 11, wherein the quantum-circuit-based state estimation solver comprises a Harrow-Hassidim-Lloyd (HHL)-based state estimation solver.

19. The apparatus according to claim 11, wherein the at least one quantum processing unit is configured to iteratively optimize the voltage and residual vectors using a gradient descent rule.

20. An apparatus to perform quantum state estimation for a microgrid system, the apparatus comprising:
at least one classical processing unit configured to obtain a general quantum state estimation model for swing-bus-contained microgrid systems and to update the quantum state estimation model to obtain eigenvectors and corresponding coefficients of the eigenvectors of a gain matrix and cost function of the quantum state estimation model; and
at least one quantum processing unit operatively coupled to the at least one classical processing unit, the quantum processing unit being configured to:
establish a state estimation formulation through quantum language;
assign a plurality of quantum registers for at least one of quantum encoding, binary representation of eigenvalues, and binary representation of electrical values during a quantum state estimation iteration;
generate a quantum-circuit-based state estimation solver configured to perform quantum phase estimation, controlled rotation, and inverse quantum phase estimation;
generate a preconditioned quantum linear solver for an ill-conditioned state estimation iteration;
iteratively optimize voltage and residual vectors while iteratively updating preconditioned errors by the quantum-circuit-based state estimation solver, the optimizing and updating iterations continuing until the preconditioned quantum linear solver reaches convergence;
obtain a quantum state estimation model for hierarchical-based microgrid systems including at least one of droop and secondary control modes;
establish an enhanced quantum state estimation framework including the quantum-circuit-based state estimation solver and the preconditioned quantum linear solver for well-conditioned and ill-conditioned hierarchical-based microgrids, respectively; and
utilize the quantum-circuit-based state estimation solver to generate an enhanced state estimation output for controlling one or more parameters of the microgrid system.
